(19) United States
(12) Patent Application Publication
(10) Pub. No.: US 2024/0248061 A1
(43) Pub. Date: Jul. 25, 2024

(54) DIELECTROPHORESIS AND IMPEDANCE DEVICES FOR INTEGRATION OF ELECTRICAL FIELD-BASED PARTICLE SORTING, ENRICHMENT, RECOVERY, AND CHARACTERIZATION

(71) Applicant: CytoRecovery, Inc, Blacksburg, VA (US)

(72) Inventors: Alexandra Rochelle HYLER, Christiansburg, VA (US); Devin Monroe KECK, Washington, DC (US); Ridi BARUA, Blacksburg, VA (US)

(21) Appl. No.: 18/423,066

(22) Filed: Jan. 25, 2024

Related U.S. Application Data
(60) Provisional application No. 63/440,972, filed on Jan. 25, 2023.

(51) Int. Cl. G01N 27/447; B03C 5/00; B03C 5/02; G01N 15/12

(52) U.S. Cl. CPC G01N 27/44791; B03C 5/005; B03C 5/026; G01N 15/12; G01N 27/44769

(57) ABSTRACT

Disclosed herein are dielectrophoresis (DEP) devices having an alignment region, a DEP region, and an analysis region for characterizing particles. Disclosed herein are methods of characterizing particles, the methods include aligning particles along one or more walls of a microfluidic device, applying a non-uniform electric field to the particles, receiving the particles in a plurality of outlet channels, respectively, based on one or more electrical properties of the plurality of particles, passing at least one of the particles in one of the plurality of outlet channels through an impedance detector, and/or detecting an impedance measurement characteristic of at least one property of the at least one of the particles.

### CROSS-REFERENCE TO RELATED APPLICATIONS

This application claims priority to U.S. Provisional application 63/440,972 filed on Jan. 25, 2023, which is incorporated herein in its entirety.

### FIELD OF THE INVENTION

The present invention relates to devices and methods for dielectrophoresis (DEP) and impedance detection for manipulation, recovery, and characterization of cells or particles.

### BACKGROUND OF THE INVENTION

Isolation and enrichment of cells/micro-particles from a biological sample is one of the first crucial processes in many biomedical and homeland security applications. Water quality analysis to detect viable pathogenic bacterium and the isolation of rare circulating tumor cells (CTCs) for early cancer detection are important examples of the applications of this process. Conventional methods of cell concentration and separation include centrifugation, filtration, fluorescence activated cell sorting, or optical tweezers. Each of those techniques relies on different cell properties for separation and has intrinsic advantages and disadvantages. For instance, many of the known techniques require the labeling or tagging of cells in order to obtain separation. Those more sensitive techniques may require prior knowledge of cell- specific markers and antibodies to prepare target cells for analysis.

Dielectrophoresis (DEP) is the motion of a particle in a suspending medium due to the presence of a non-uniform electric field. DEP utilizes the electrical properties of the cell/particle and the media as well as unique electrode geometries and configurations to induce specific cell/particle motion through polarization which can be utilized for a variety of applications including; sample purification, cell/particle patterning, cell identification, cell separation, cell lysis, ect. The strength and direction of induced motion for any particular cell will depend on many different variables including but not limited to the amplitude and frequency of the electric field, the size and shape of the cells of interest, the electrical properties of the cells and the suspending media, and the unique electrode geometry and configuration.

The use of DEP for cell separation has been studied extensively in the last two decades. This is illustrated by its' proven success in the field of cell separation. DEP has been utilized for the successful separation of human leukemia cells from red blood cells in an isotonic solution, entrapment of human breast cancer cells from blood, and separation of U937 human monocytic from peripheral blood mononuclear cells (PBMC). Additionally, DEP has also been used to separate neuroblastoma cells from HTB glioma cells, isolate cervical carcinoma cells, isolate K562 human CML cells, separate live yeast cells from dead, and segregate different human tumor cells. Other examples are described in U.S. Pat. No. 8,968,542 (“the '542 patent”), issued on Mar. 3, 2015, the entirety of which is incorporated by reference herein.

FIG. 1 is an example of a batch processing insulating DEP device 111 from the '542 patent. DEP device 111 is fabricated on a substrate 119 and includes a sample channel 117 for placing the cells to be separated. The term insulating DEP is used in reference to the unique geometry and configuration of the electrodes used in this particular DEP device. In DEP device 111 the electrodes are injection molded to take the shape of channels 113 and 115 and then electrically interfaced with a function generator at points 114 and 116. These electrodes are intentionally fabricated outside the main flow through channel 117 to establish a base electric field across the channel 117. In the main channel 117 insulating flexible 3D pillars of unique geometry and material are used to distort the electric field across the channel and create regions of high and low electric field gradients. The sharp differences in electric field gradients combined with the unique electrical properties of the targeted cells and suspending media facilitate the manipulation of cells, for example trapping of specific cells on insulating pillars or other regions.

While these prior DEP devices are suitable for certain separation applications, they require supplementary off-chip processes to make the separation more efficient. For example, these devices require a specific base sample concentration of cells to facilitate effective separation. Typically, this is achieved through centrifugation. In addition, the separation is done through batch processing as opposed to continuous flow and typically requires confirmation through data intensive post processing of videos for each batch processed. Each of the supplementary processes used in tandem with the DEP device-based separation decrease the efficiency and throughput of the separation and introduce additional opportunities for cell death and variations in the separation.

### BRIEF SUMMARY OF THE INVENTION

Disclosed herein are dielectrophoresis (DEP) devices. In one general aspect of the disclosure DEP devices also include an alignment region. The DEP devices may also include a DEP region. The DEP devices may also include an analysis region. In one aspect of the disclosure, disclosed DEP devices include an alignment region, a DEP region, and an analysis region are connected by a fluid channel. In another aspect of the disclosure, a fluid channel is formed in a single substrate. In yet anpother aspect of the disclosure, a DEP region may include a fluid channel and a plurality of electrodes adapted to emit a non-uniform electric field within the fluid channel. In yet another aspect of the disclosure, a plurality of electrodes are electrically connected to an alternating current signal.

In one aspect of the disclosure, an analysis region may include a fluid channel and a plurality of outlet channels, the non-uniform electric field is adapted to enact DEP forces on a plurality of particles within the DEP region such that the plurality of particles are moved into one of the plurality of outlet channels based on one or more electrical properties of the plurality of particles. In another aspect of the disclosure a plurality of particles are linearized, respectively, entering each of a plurality of outlet channels. In yet another aspect of the disclosure a plurality of outlet channels may include an odd number of outlet channels, a center outlet channel and at least two outer outlet channels, and where the particles moved to the center outlet channel may include different electrical properties than the particles moved to the outer outlet channels. In yet another aspect of the disclosure, a fluid channel is formed on a single DEP devices chip. In another aspect of the disclosure an alignment region may include a channel having a plurality of bends.

In one aspect of the disclosure, a plurality of particles within an alignment region are linearized, respectively, on one or more walls of the alignment region. In another aspect of the disclosure, an alignment region has an alignment region inlet and an alignment region outlet and a plurality of particles within the alignment region are more linearized at the alignment region outlet than at the alignment region inlet. In yet another aspect of the disclosure, an alignment region may include a textured bottom surface sufficient to induce at least one of eddies or vortexes in a fluid passing through the alignment region. In another aspect of the disclosure, an analysis region may include a plurality of outlet channels.

In one aspect of the disclosure, a plurality of outlet channels are symmetric across a longitudinal center line of the disclosed DEP devices. In another aspect of the disclosure, the DEP devices may include at least one sensor. In another aspect of the disclosure at least one sensor is an impedance detector. In yet another aspect of the disclosure an impedance detector may include at least one working electrode and at least one counter electrode adapted to may include an electric field therebetween when an alternating current signal is applied to the at least one working electrode and the at least one counter electrode. In yet another aspect of the disclosure, an alternating current signal is a summation of multiple alternating current frequency signals. In yet another aspect of the disclosure at least one sensor is located in an outlet channel.

Disclosed herein are methods of characterizing particles. In one general aspect of the methods, the methods may include aligning particles along one or more walls of a microfluidic device. In another general aspect, the methods may include applying a non-uniform electric field to the particles. In yet another general aspect, the methods may include, receiving the particles in a plurality of outlet channels, respectively, based on one or more electrical properties of the plurality of particles. In another general aspect, the methods may include passing at least one of the particles in one of the plurality of outlet channels through an impedance detector. In another general aspect, the methods may include detecting an impedance measurement characteristic of at least one property of the at least one of the particles.

In one aspect of the disclosure aligning particles along one or more walls of a microfluidic device includes passing particles through a plurality of bends. In another aspect of the disclosure disclosed methods may include forming single streams of particles, respectively, along one or more walls of a microfluidic device. In yet another aspect of the disclosure, the methods may include subjecting particles to one or more dielectrophoresis (DEP) forces. In another aspect of the disclosure, receiving particles in a plurality of outlet channels may further include receiving particles in an odd number of outlet channels symmetric across a longitudinal center line of the microfluidic device. In another aspect of the disclosure, a plurality of outlet channels may include, respectively, an impedance detector.

### BRIEF DESCRIPTION OF THE FIGURES

FIG. 1 shows a prior art DEP device;

FIG. 2 shows a schematic view of a DEP device in accordance with disclosed embodiments;

FIG. 3 shows a schematic view of a DEP device in accordance with disclosed embodiments;

FIG. 4 shows a schematic view of a sensor used in a DEP device in accordance with disclosed embodiments;

FIG. 5 shows a schematic view of a DEP device in accordance with disclosed embodiments;

FIG. 6 shows a schematic view of a DEP region and an analysis region in accordance with disclosed embodiments;

FIG. 7 shows a schematic view of an alignment region in accordance with disclosed embodiments;

FIG. 8 shows a schematic view of a DEP device in accordance with disclosed embodiments; and

FIG. 9 shows a schematic view of a DEP region and an analysis region in accordance with disclosed embodiments.

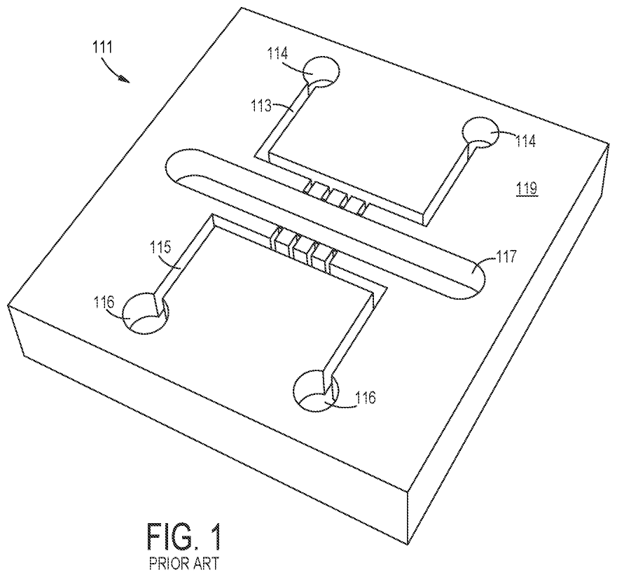

### DETAILED DESCRIPTION OF THE INVENTION

Disclosed herein are DEP device designs and methods that include additional on device features used to improve the efficiency and throughput of prior DEP devices for a multitude of biological applications including but not limited to separation, identification, characterization, enrichment, purification, etc.

Disclosed herein are micro-scale device designs that combine inertial based focusing, unique electrode configuration and geometry, and impedance-based quantification to induce specific electric field-based cell responses and analyses more efficiently and at a higher throughput than prior DEP based devices. Device designs disclosed here include an inertial focusing region (also referred to herein as an alignment region) to align an incoming heterogeneous population of cells/particles into concentrated localized streams of cells or particles. Localized streams of the heterogeneous cell population flow into a DEP region (also referred to as a sorting region) that uses a unique electrode geometry and configuration to provide a specific electrical treatment to the heterogeneous population. In the DEP region, the electrode geometry and configuration is designed to produce an electric field that causes cells/particles to migrate cells out of the localized streams based on their unique electric properties in order to facilitate downstream separation, identification, characterization, enrichment, purification, etc. Additionally, the design presented here facilitates the continuous flow of cells/particles as opposed to the batch processing seen in previous DEP devices. Cells of similar electrical properties will migrate to similar regions within the device. Depending on the number of cells or particle of interest devices can be designed to have multitude of outlets to separate or characterize the initial heterogenous sample as desired. Regions of the disclosed devices may also include an on-chip analysis region (also referred to as a characterization region) in which a unique configuration of additional electrodes will be used as a sensor to measure specific metrics while simultaneously processing the sample. For example, impedance measurements of single or multiple cells at the inlet and/or each outlet may be used to quantify, characterize, and identify cell/particle properties such as species, size, mass, volume, viability, count, and other biophysical metrics. While the designs disclosed herein may provide examples of the alignment region, the DEP region, and the on-chip analysis region in particular orders and of specific geometries, it should be noted that other designs, using the disclosure herein may also be implemented in which different channel geometries, electrode geometries, or different combinations of each region may be also be used. For example, the on-chip analysis region could be employed at a number of positions within the device. Analysis may be employed prior to the alignment region, and/or between the alignment and the DEP regions; in either case either in place of or in addition to a downstream analysis region for additional quantification. Devices may further include additional electrode geometries and configurations as well as integrated electronics that may include but is not limited to an amplifier, signal generator, & processor/imaging integrated thereto. Further detailed descriptions are provided in the below examples.

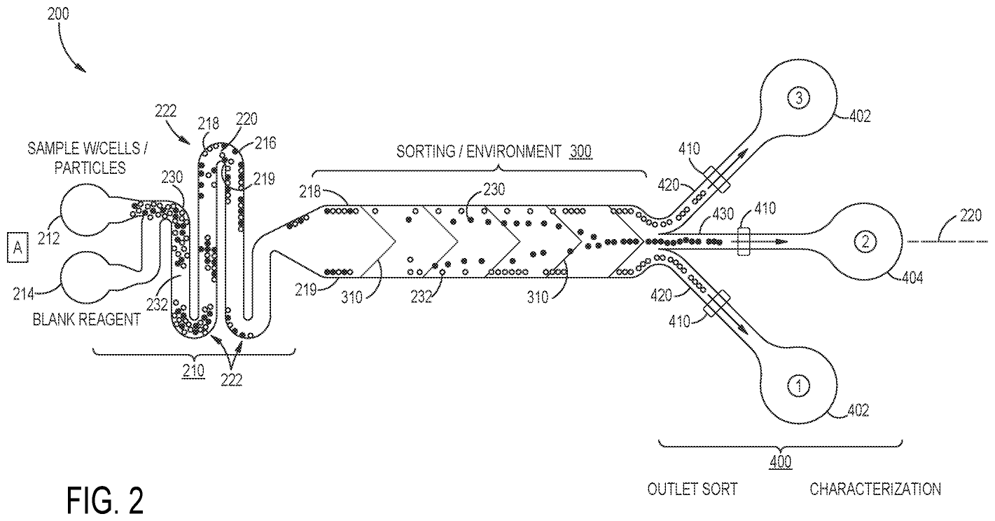

FIG. 2 shows a schematic view of a DEP device 200 having an alignment region 210, a DEP region 300, and an analysis region 400. As shown in FIG. 2, the flow of cells or particles is generally from left to right. For simplicity, the remainder of this disclosure will refer to just particles with the understanding that references to particles includes cells. The alignment region 210 has one or more sample inlets 212 for inserting particles to be processed, and may also include one or more buffer inlets 214 for insertion of blank reagents to aid in the fluid flow through the DEP device 200. As shown schematically, first particles 230 (depicted schematically as a solid fill circle) and second particles 232 (depicted schematically as circle having no fill) are inserted at sample inlet 212 and carried through the DEP device 200 under fluidic pressure, which may be provided by an external pump or syringe. Although FIG. 2 depicts only two different populations of particles/cells, heterogenous populations may consist of more than two different cell/particles. The first and second particles 230, 232 have differing electrical properties such in the applied electric field induces movement out of the focused stream of cells to allow for their separation in the DEP region 300 and analysis in the analysis region 400.

The alignment region 200 may include a left wall 218 and a right wall 219 defining a channel 220 having a tortuous path. The convention of “left” and “right” in this context of the wall is with respect to one or more particles 230, 232 traveling from the inlet 212 to one or more of the outlets 402, 404 and will be used throughout this disclosure. The tortuous path of the channel 220 includes one or more bends 222 which, due to the inertia of the particles 230, 232 traveling through the channel 220, will cause the particles 230, 232 migrate to either left wall 218 or right wall 219 depending on the individual particle properties and starting locations across the channel 220. Such migration along the respective walls 218, 219 will also cause the particles 230, 232 to form single file streams of particles 230, 232 along the respective wall 218, 219. While only three bends 222 are shown in FIG. 2, additional bends 222 may also be included. As more bends 222 are added to the DEP device 200, the alignment of the particles 230, 232 along the wall 218, 219 will be more complete and closer to completely single file. As, the total number of particles 230, 232 present in the alignment region 200 increases (as concentration goes up) or if the individual sizes of the particles 230,232 increases, more bends 222 may be required to align the particles 230,232 along the walls 218,219. However, an increase in the number of bends may also decrease particle velocity through the channel 220 and result in particle stagnation or settling. As such, any particular DEP device design will include a balance of such considerations. Providing a tortuous channel 220 with a plurality of bends 222, e.g., having a serpentine path, contributes to the DEP device 200's ability to align the particles without the need for the added space of a cell concentrator while also allowing for slower flow rates, which ultimately minimizes sheer on the particles 230, 232, which may otherwise damage the particles. While a serpentine tortuous channel 220 is shown, other configurations for aligning cells may also include, for example bump arrays, changing channel cross sections or any method that alters the flow pattern/dispersion of particles/cells such that they migrate into concentrated streamlines

For example, the channel 220 may include three or more bends 220, four or more bends 220, five or more bends 220, six or more bends 220, or seven or more bends 220. For purposes of this disclosure, a bend will be considered any turn or curve in the channel greater than about 10 degrees. The channel 220 has a bottom surface between and connecting the left and right walls 218, 219. As discussed further below, and optionally, the channel 220 may include a textured bottom surface 224 (see, FIG. 7) to induce eddies or vortexes, which may further help particle 230, 232 positioning.

Fluidically connected to alignment region 210 is DEP region 300. DEP region 300 is configured to provide dielectrophoretic particle differentiation/sorting. The DEP region 300 includes electrodes 310 associated with the channel 220, e.g, within, next to, or under channel 220, for emitting a non-uniform electric field within the channel 220 within the DEP region 300. Electrodes 310 may be any appropriate DEP configuration, including contactless or contacting configurations, for example those associated with insulator-based DEP (iDEP), light or laser induced DEP (LiDEP), contactless DEP (cDEP), or other electrode configurations. As shown, the electrodes 310 are configured into a chevron a pattern, although other configurations and patterns may also be used. The electrodes 310 work in conjunction with an alternating current signal generator (not shown) to generate a non-uniform electric field. For example, the non-uniform electric field may be generated such that a positive DEP response is instigated in a subset of the particles, e.g., particles 230, which draws the particles 230 towards the longitudinal center line 240 of the channel 220. The electric field may also instigate a negative DEP response, or no DEP response in other particles, e.g., particles 232, which allows the particles 232 to continue movement along the left 218 and right 219 walls. It should also be noted that the electrode 310 and electric fields can be configured such that a negative DEP response draws certain particles to the center of the channel 220 while a positive DEP response causes the remainder of the particles to continue movement along the walls 218, 219 walls. The particular configuration will depend on the type of particles being separated, and the electric field and electrode configuration. Regardless of the particular configuration, the particles 230, 232 exhibit different DEP responses to the electric field such that a DEP force is imparted onto one of the particle types (230 as shown) towards the longitudinal centerline 240 of the channel 220, while other particle types (232 as shown) remain along the walls 218, 219. Additional information regarding DEP sorting may be found, for example, in Jian et. al, High-throughput continuous dielectrophoretic separation of neural stem cells, Biomicrofluidics 13, 064111 (2019), the entirety of which is incorporated by reference herein.

Fluidically connected to the DEP region 300 is on-on-chip analysis region 400 configured to receive the sorted particles 230, 232. The analysis region 400 includes a plurality of outlet channels arranged symmetrically across the longitudinal center line 240. For example, outer outlet channels 420 and center outlet channel 430. Each of the of the outlet channels 420, 430 are arranged to receive different streams of particles 230, 232, sorted from the DEP region 300. For example, outer outlet channels 420 receive the particles 232 from the left and right walls 218, 219, while center outlet channels 430 receive the particles 230 that were drawn toward the longitudinal center line 240 through DEP forces in the DEP region 300.

One or more of the outlet channels 420, 430 may include one or more additional electrodes to function as sensors 410, which are schematically represented by dashed regions and will be discussed further below. Because particles 230, 232 have been linearized by the alignment region 210 and sorted by the DEP region 300, the sensors 410 can more accurately measure a multitude of properties for the respective particles 230, 232 as they pass through the sensors 410. Following, the sensors 410, the particles 230, 232 will each exit the device at their respective outlets 402, 404 where each sample may be collected individually from the DEP device 200.

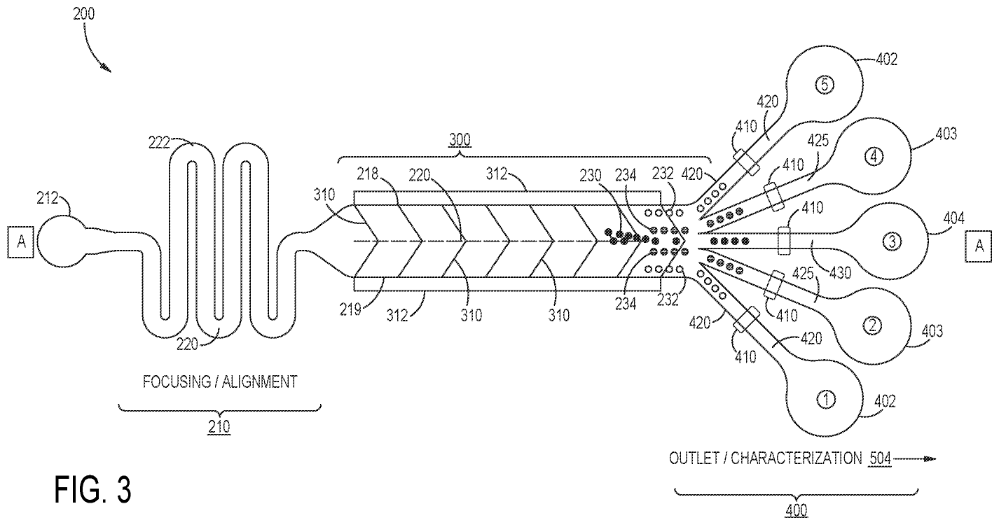

FIG. 3 shows a schematic representation of another DEP device 200 which is similar to that of FIG. 2. However, the alignment region 210 is shown having additional bends 222 in the channel 220. Additionally, the DEP device 200 of FIG. 3 is shown having third particles 234 shown schematically as patterned circles. Note that first, second, and third particles 230, 232, 234 have been omitted from most of FIG. 3 for clarity. Third particles 234 have a DEP response that is between that of the first particle 230 and the second particle 232 for the particular non-uniform electric field generated by the electrodes. The result is that the third particles 234 are pulled partially toward the longitudinal center line 240, more so than the second particles 232, but less so than the first particles 230, such that they reside physically between the first particles 230 and the second particles 232.

Accordingly, the DEP device 200 of FIG. 3 may include additional outlet channels, sensors, and outlets for the additional particles. For example, as shown in FIG. 3, the DEP device 200 further includes middle outlet channels 425 and outlets 403 for each of the additional channels for receiving the third particle 234. The configuration of the outlet channels and outlets is flexible based on the number of different types of particles to be separated. For example, FIG. 2 shows a configuration with 3 outlet channels, FIG. 3 shows a configuration with 5 outlet channels, and additional configurations are also available. For example, 4, 6, 7, 8, 9, 10, 11, etc. Typically, a configuration with a centerline channel will result in an odd number of outlet channels, while a configuration without a centerline channel will result in an even number of outlet channels. Either, though, may be symmetric across the longitudinal center line 240 of the channel 220. Either specific configuration will depend on the DEP response of the particles to be separated and characterized.

Also shown in FIG. 3 are electrode pads 312, which may form the electrical connection for the electrodes 310 to the signal generator, although such connections are not shown in the figure.

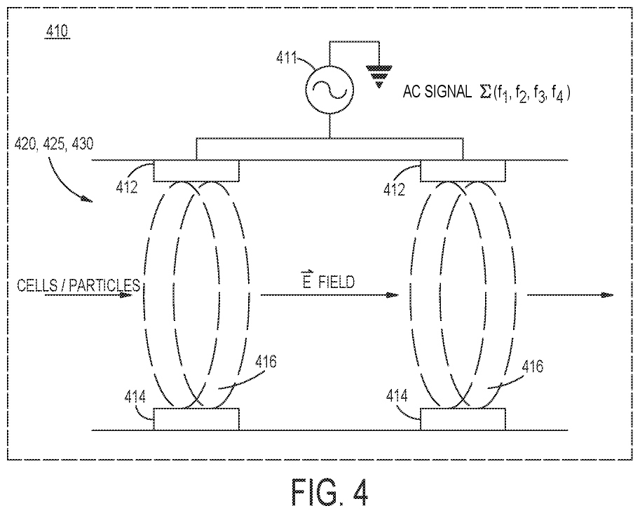

FIG. 4 shows a schematic representation of the electrical field generated in a sensor 410, for example those shown in FIGS. 2 and 3. The sensor 410 may be an impedance based sensor that measures changes to the impedance of an alternating current (AC) signal due to the passing of a particle (e.g., one of first particles 230, second particles 232, or third particles 234) passing through and disturbing the electric field 416 generated between one or more working electrodes 412 and counter electrodes 414. Such impedance measurements may be similar to those described in US 2022/0091014 to Swami et al, U.S. Pat. No. 11,339,417 to Swami et. al, and/or Salahi et al. Modified Red Blood Cells as Multimodal Standards for Benchmarking Single-Cell Cytometry and Separation Based on Electrical Physiology, Anal Chem., 2022 Feb. 15;94(6):2865-2872, the entirety of each of which are incorporated by reference herein. Further, the AC signal 411 may be summation of multiple generated frequencies, e.g. the sum of wave functions F1, F2, F3, F4, etc. In one example, each of the simultaneously generated frequencies may be used to discern different characteristics of the passing particles. Further, certain frequencies may be probing frequencies.

Additionally, while the working electrodes 412 and counter electrodes 413 are shown on opposite sides of the outlet channel 425, they need not be. For example, the working electrodes 412 and counter electrodes 413 may be on the same side of a given outlet channel for a sensor 410. Because the particles have been linearized by the alignment region 210 and sorted by the DEP region 300, any given impedance measurement has a higher probability of representing the characteristics of a single particle passing through the electric field 416, which increases the accuracy and continues throughput of the sensor 410.

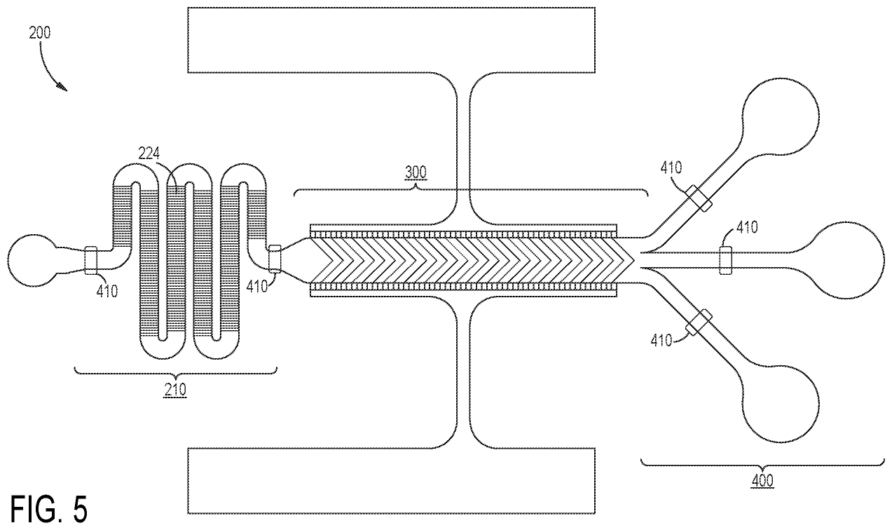

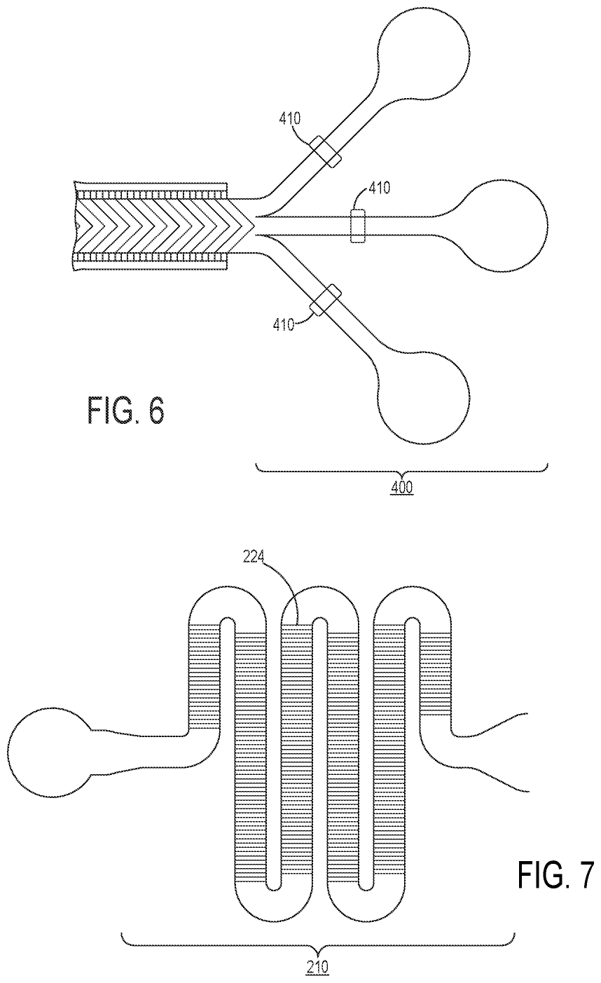

FIGS. 5-7 show additional example embodiments of DEP device 200, with FIGS. 6 and 7 being magnified views of regions of FIG. 5, although the layout is shown reversed with flow generally from right to left instead of left to right. Optionally, or additionally, sensors 410 are also at the beginning and/or end of the alignment region 210, which may provide additional options for the characterization of particles input into the DEP device 200 at different stages. Further, alignment region 210 is shown with an example textured bottom surface 224.

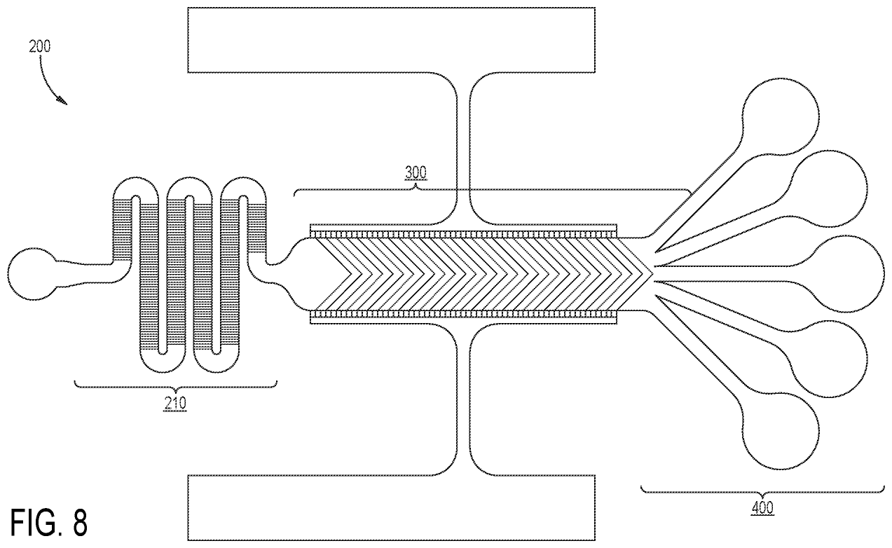

FIG. 8 shows an additional example embodiment of DEP device 200 similar to that shown in FIG. 5-7, however analysis region 400 is shown including five output channels similar to DEP device 200 described with reference to FIG. 3.

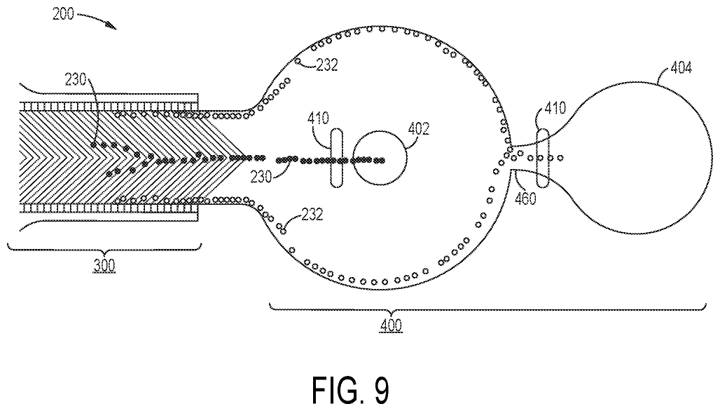

While prior disclosed embodiments have described a plurality of output channels arranged symmetrically across the longitudinal center line with outlets arranged in a fanned or periodic configuration with outlets spaced evenly from the center line, other configurations and geometries may also be used. For example, as shown in FIG. 9, are example configurations of DEP region 300 and analysis region 400. DEP region 300 of FIG. 9 is similar to previously described DEP regions 300 and may alternatively or additionally include sensors 410 prior to or after DEP region 300 as discussed previously.

Analysis region 400 includes a primary output channel 450 and a secondary output channel 460 fluidically connected to the primary output channel 450. In operation, the first particles 230 that are moved toward the center line (through dielectric forces in the DEP region 300), continue into the primary output channel 450 through sensor 410 for characterization/analysis and then to outlet 402. As shown, primary outlet channel 450 includes outer walls that promote second particles 232 to migrate around the outlet 402 and into secondary output channel 460 (also positioned across the center line) for characterization by the associated sensor 410. The second particles 232 will then proceed to outlet 404.

What is claimed is:

1. A dielectrophoresis (DEP) device comprising:
an alignment region;
a DEP region; and
an analysis region.

2. The DEP device of claim 1, wherein the alignment region, the DEP region, and the analysis region are connected by a fluid channel.

3. The DEP device of claim 2, wherein the fluid channel is formed on a single DEP device chip.

4. The DEP device of claim 2, wherein the fluid channel is formed in a single substrate.

5. The DEP device of claim 1, wherein the alignment region comprises a channel having a plurality of bends.

6. The DEP device of claim 1, wherein the alignment region comprises a textured bottom surface sufficient to induce at least one of eddies or vortexes in a fluid passing through the alignment region.

7. The DEP device of any of claim 5, wherein a plurality of particles within the alignment region are linearized, respectively, on one or more walls of the alignment region.

8. The DEP device of any of claim 7, wherein the alignment region has an alignment region inlet and an alignment region outlet and the plurality of particles within the alignment region are more linearized at the alignment region outlet than at the alignment region inlet.

9. The DEP device of claim 1, wherein the analysis region comprises a plurality of outlet channels.

10. The DEP device of claim 9, wherein the plurality of outlet channels are symmetric across a longitudinal center line of the DEP device.

11. The DEP device of claim 1, further comprising at least one sensor.

12. The DEP device of claim 11, wherein the at least one sensor is an impedance detector.

13. The DEP device of claim 12, wherein the impedance detector comprises at least one working electrode and at least one counter electrode adapted to comprise an electric field therebetween when an alternating current signal is applied to the at least one working electrode and the at least one counter electrode.

14. The DEP device of claim 13, wherein the alternating current signal is a summation of multiple alternating current frequency signals.

15. The DEP device of claim 11, wherein the at least one sensor is located in an outlet channel.

16. The DEP device of claim 2, wherein the DEP region comprises the fluid channel and a plurality of electrodes adapted to emit a non-uniform electric field within the fluid channel.

17. The DEP device of claim 16, wherein the plurality of electrodes are electrically connected to an alternating current signal.

18. The DEP device of claim 16, wherein the analysis region further comprises the fluid channel and a plurality of outlet channels, the non-uniform electric field is adapted to enact DEP forces on a plurality of particles within the DEP region such that the plurality of particles are moved into one of the plurality of outlet channels based on one or more electrical properties of the plurality of particles.

19. The DEP device of claim 18, wherein the plurality of particles are linearized, respectively, entering each of the plurality of outlet channels.

20. The DEP device of claim 18, wherein the plurality of outlet channels comprises an odd number of outlet channels, a center outlet channel and at least two outer outlet channels, and wherein the particles moved to the center outlet channel comprise different electrical properties than the particles moved to the outer outlet channels.

21. A method of characterizing particles, the method comprising:
aligning particles along one or more walls of a microfluidic device;
applying a non-uniform electric field to the particles;
receiving the particles in a plurality of outlet channels, respectively, based on one or more electrical properties of the plurality of particles;
passing at least one of the particles in one of the plurality of outlet channels through an impedance detector; and
detecting an impedance measurement characteristic of at least one property of the at least one of the particles.

22. The method of claim 21, wherein aligning particles along one or more walls of the microfluidic device comprises passing the particles through a plurality of bends.

23. The method of claim 22, further comprising forming single streams of the particles, respectively, along the one or more walls of the microfluidic device.

24. The method of claim 21, further comprising subjecting the particles to one or more dielectrophoresis (DEP) forces.

25. The method of claim 21, wherein receiving the particles in a plurality of outlet channels further comprises receiving the particles in an odd number of outlet channels symmetric across a longitudinal center line of the microfluidic device.

26. The method of claim 21, wherein a plurality of outlet channels comprises, respectively, an impedance detector.
